(19) United States
(12) Patent Application Publication
(10) Pub. No.: US 2022/0386188 A1
(43) Pub. Date: Dec. 1, 2022

(54) CELL HANDOVER METHOD AND DEVICE

(71) Applicant: VIVO MOBILE COMMUNICATION CO., LTD., Dongguan (CN)

(72) Inventors: Ang YANG, Dongguan (CN); Peng SUN, Dongguan (CN)

(73) Assignee: VIVO MOBILE COMMUNICATION CO., LTD., Dongguan (CN)

(21) Appl. No.: 17/886,632

(22) Filed: Aug. 12, 2022

Related U.S. Application Data
(63) Continuation of application No. PCT/CN2021/075279, filed on Feb. 4, 2021.

(30) Foreign Application Priority Data
Feb. 12, 2020 (CN) 202010089400.X

(51) Int. Cl. H04W 36/00; H04W 36/08; H04W 16/28; H04L 5/00; H04W 74/08

(52) U.S. Cl. CPC H04W 36/0061; H04W 36/08; H04W 16/28; H04L 5/0051; H04W 74/0833

(57) ABSTRACT

A cell handover method and a device are provided. The method is executed by a terminal device and includes: handing over to a target cell or a target TRP in a case that at least one of the following is satisfied: a first CORESET is associated with the target cell or the target TRP; related information of a first TRP points to the target cell or the target TRP; a first RS points to the target cell or the target TRP; a first TCI points to the target cell or the target TRP; first spatial relation information points to the target cell or the target TRP; or a first RACH resource points to the target cell or the target TRP.

### CROSS-REFERENCE OF RELATED APPLICATION

This application is a continuation of International Application No. PCT/CN2021/075279, filed Feb. 4, 2021, which claims priority to Chinese Patent Application No. 202010089400.X, filed Feb. 12, 2020. The entire contents of each of the above-referenced applications are expressly incorporated herein by reference.

### TECHNICAL FIELD

Embodiments of the present application relate to the field of communications, and in particular, to a cell handover method and a device.

### BACKGROUND

Cell handover is mostly performed by means of assistance by a terminal device. For example, a network device selects, according to a measurement report reported by a terminal device, a target cell for handover.

A process of cell handover in the related art is as follows: 1. A source cell instructs handover and transmits a handover request to a target cell; 2. The target cell performs admission control, provides a Radio Resource Control (RRC) configuration, and sends the RRC configuration to the source cell as a part of the handover admission; 3. The source cell sends an RRC reconfiguration message including a handover command to the terminal device; and 4. The terminal device performs an RRC connection to the target cell and replies that the handover is completed.

It can be seen that during cell handover, the network device needs to send an RRC reconfiguration message to explicitly instruct the terminal device to perform handover, which causes a long delay and is inflexible.

### SUMMARY

The purpose of the embodiments of the present application is to provide a cell handover method and a device.

A first aspect provides a cell handover method. The method is executed by a terminal device and includes: handing over to a target cell or a target TRP in a case that at least one of the following is satisfied: a first control resource set (CORESET) is associated with the target cell or the target TRP; related information of a first TRP points to the target cell or the target TRP; a first reference signal (RS) points to the target cell or the target TRP; a first transmission configuration indication (TCI) points to the target cell or the target TRP; first spatial relation information points to the target cell or the target TRP; or a first random access channel (RACH) source points to the target cell or the target TRP.

A second aspect provides a cell handover method. The method is executed by a network device and includes: configuring for a terminal device that the terminal device is instructed to hand over to a target cell or a target TRP in a case that at least one of the following is satisfied: a first CORESET is associated with the target cell or the target TRP; related information of a first TRP points to the target cell or the target TRP; a first RS points to the target cell or the target TRP; a first TCI points to the target cell or the target TRP; first spatial relation information points to the target cell or the target TRP; or a first RACH resource points to the target cell or the target TRP.

A third aspect provides a terminal device, including: a cell handover module, configured to hand over to a target cell or a target TRP in a case that at least one of the following is satisfied: a first CORESET is associated with the target cell or the target TRP; related information of a first TRP points to the target cell or the target TRP; a first RS points to the target cell or the target TRP; a first TCI points to the target cell or the target TRP; first spatial relation information points to the target cell or the target TRP; or a first RACH resource points to the target cell or the target TRP.

A fourth aspect provides a network device, including: a configuration module, configured to configure for a terminal device that the terminal device is instructed to hand over to a target cell or a target TRP in a case that at least one of the following is satisfied: a first CORESET is associated with the target cell or the target TRP; related information of a first TRP points to the target cell or the target TRP; a first RS points to the target cell or the target TRP; a first TCI points to the target cell or the target TRP; first spatial relation information points to the target cell or the target TRP; or a first RACH resource points to the target cell or the target TRP.

A fifth aspect provides a terminal device, including: a processor, a memory, and a computer program stored in the memory and executable on the processor. When the computer program is executed by the processor, steps in the cell handover method provided in the first aspect are implemented.

A sixth aspect provides a network device, including: a processor, a memory, and a computer program stored in the memory and executable on the processor. When the computer program is executed by the processor, the steps of the cell handover method provided in the second aspect are implemented.

A seventh aspect provides a computer-readable storage medium, storing a computer program. When the computer program is executed by the processor, the cell handover method provided in either of the first aspect and the second aspect is implemented.

The embodiments of the present application provide various manners to implicitly instruct the terminal device to perform cell handover, and the network device does not need to explicitly send RRC reconfiguration signaling, which improves the flexibility of the system and reduces the cell handover delay.

### BRIEF DESCRIPTION OF DRAWINGS

The accompanying drawings illustrated herein are provided to further understand the present application and form a part of the present application. The exemplary embodiments of the present application and the descriptions thereof are used to explain the present application and do not constitute an improper limitation on the present application. In the accompanying drawings:

FIG. 1 is a schematic flowchart of a cell handover method according to an embodiment of the present application;

FIG. 2 is a schematic flowchart of a cell handover method according to another embodiment of the present application;

FIG. 3 is a schematic structural diagram of a terminal device according to an embodiment of the present application;

FIG. 4 is a schematic structural diagram of a network device according to an embodiment of the present application;

FIG. 5 is a schematic structural diagram of a terminal device according to another embodiment of the present application; and

FIG. 6 is a schematic structural diagram of a network device according to another embodiment of the present application.

### DETAILED DESCRIPTION OF EMBODIMENTS

To make the objectives, technical solutions, and advantages of the present application clearer, the following clearly describes the technical solutions of the present application with reference to the specific embodiments of the present application and the corresponding accompanying drawings. Apparently, the described embodiments are merely some rather than all of the embodiments of the present application. All other embodiments obtained by those of ordinary skill in the art based on the embodiments of the present application without creative efforts should fall within the protection scope of the present application. The term “and/or” in the embodiments of this specification indicates at least one of the former item or the latter item.

It should be understood that the technical solutions in the embodiments of the present application may be applied to various communication systems, such as a Long Term Evolution (LTE) system, an LTE Frequency Division Duplex (FDD) system, LTE Time Division Duplex (TDD), a Universal Mobile Telecommunication System (UMTS) or a Worldwide Interoperability for Microwave Access (WiMAX) communication system, a 5G system, or a New Radio (NR) system, or a subsequent evolved communication system.

In the embodiments of the present application, a terminal device may include, but is not limited to a Mobile Station (MS), a mobile terminal, a mobile telephone, user equipment UE), a handset, portable equipment, a vehicle, and the like. The terminal device may communicate with one or more core networks by using a Radio Access Network (RAN). For example, the terminal device may be a mobile telephone (or referred to as a “cellular” telephone), or a computer having a wireless communication function; or the terminal device may be a portable, pocket-sized, handheld, computer built-in, or vehicle-mounted mobile apparatus.

In the embodiments of the present application, a network device is an apparatus that is deployed in a radio access network and that is configured to provide a wireless communication function for the terminal device. The network device may be a base station, and the base station may include various types of macro base stations, micro base stations, relay stations, or access points. In systems using different radio access technologies, names of devices having a base station function may be different. For example, in an LTE network, the device is referred to as an evolved NodeB (eNB or eNodeB), and in a 3rd Generation (3G) network, the device is referred to as a NodeB or a network device in the subsequent evolved communications system. However, the terms do not constitute a limitation.

In the related art, during cell handover, the network device needs to send an RRC reconfiguration message to explicitly instruct the terminal device to perform handover, which has a long delay and is inflexible.

A Control Resource Set (CORESET) is configuration information of a Physical Downlink Control Channel (PDCCH) of the terminal device. If a specific CORESET is associated with another cell, this is a good cell handover command. In addition to the CORESET, the embodiments of the present application also provide other effective cell handover solutions, for example, related information of a Transmission and Reception Point (TRP) is associated with another cell, a Reference signal (RS) as beam reference information is associated with another cell, and a beam indication is associated with another cell.

Before introducing the various embodiments of the present application in detail, the definition of “cell handover” mentioned in the embodiments of the present application will be explained first. Handing over to a target cell or a target TRP mentioned in various embodiments of the present application may include one of the following 1) to 7).

1) An anchor node hands over to the target cell.

2) An anchor node remains unchanged and in a case that there are multiple TRPs, a cell associated with a TRP of a non-anchor node is handed over.

In various embodiments of this specification, a TRP identifier (ID) may be a control resource set resource pool index (CORESETPoolIndex), and multiple TRPs mean that the value of CORESETPoolIndex is greater than 0.

3) Configuration information of the target cell is used.

In this example, the configuration information of the target cell includes higher layer configuration information and physical layer configuration information. a) The higher layer configuration information includes at least one of the following: cell group configuration (CellGroupConfig); special cell configuration (SpCellConfig); reconfiguration with synchronization (ReconfigurationWithSync); serving cell common configuration (ServingCellConfigCommon); or serving cell configuration (ServingCellConfig).

b) The physical layer configuration information includes at least one of the following: Transmission Configuration Indication (TCI) information; Quasi Co-Location (QCL) information; a Path Loss reference RS (PL RS); a Random Access Channel (RACH) resource; or scrambling information.

4) CORESET #0 belongs to the target cell.

5) A PDCCH belongs to the target cell.

6) A special cell (SpCell, including a primary cell and a primary secondary cell) is handed over to the target cell.

7) A network node identifier (for example, a cell ID) or network node related information associated with a resource pool index of a control resource set (CORESETPoolIndex) changes. For example, the cell ID associated with CORESETPoolIndex or related information of the cell ID changes.

It should be noted that, the network node mentioned in each embodiment of the present application may be a cell or a TRP.

The cell handover method provided by the present application will be described in detail below in multiple embodiments.

As shown in FIG. 1, an embodiment of the present application provides a cell handover method 100. The method can be executed by a terminal device, that is, the method can be executed by software or hardware installed in the terminal device. The method includes the following steps:

S102: Hand over to a target cell or a target TRP in a case that at least one of the following is satisfied: 1) a first CORESET is associated with the target cell or the target TRP; 2) related information of a first TRP points to the target cell or the target TRP; 3) a first RS points to the target cell or the target TRP; 4) a first TCI points to the target cell or the target TRP; 5) first spatial relation information points to the target cell or the target TRP; or 6) a Random Access Channel (RACH) resource points to the target cell or the target TRP.

In some embodiments, before S102, the terminal device may further perform Radio Resource Management (RRM) measurement, Radio Link Management (RLM) measurement, beam measurement, or the like according to current cell configuration, and after completing related measurement, the terminal device may perform RRM reporting, RLM reporting, or beam reporting.

According to measurement content reported by the terminal device, the network device may configure/update/activate at least one of the foregoing for the terminal device, and instruct the terminal device to perform cell handover. In this way, the terminal device can hand over from a source cell to the target cell or the target TRP when finding that at least one of the above-mentioned conditions is satisfied. That is, in the case that at least one of the foregoing is satisfied, the terminal device performs cell handover. In some embodiments, the terminal device can perform RRC connection to the target cell or the target TRP, and reply that the handover is completed.

It can be seen that the configuration of at least one of the above conditions is related to the target cell or the target TRP. In this way, the terminal device can directly use the above configuration when performing cell handover, which reduces the cell handover delay.

The embodiments of the present application provide various manners to implicitly instruct the terminal device to perform cell handover, and the network device does not need to explicitly send RRC reconfiguration signaling, which improves the flexibility of the system and reduces the cell handover delay.

The multiple conditions mentioned in the embodiment 100 will be described in detail below in terms of various embodiments.

(1)

The first CORESET is associated with the target cell or the target TRP mentioned in 1) of the embodiment 100.

In some embodiments, the first CORESET includes at least one of the following: a CORESET #0; a CORESET with the smallest index; a CORESET with the largest index; a CORESET configured by the network device; or a CORESET reported by the terminal device.

In some embodiments, that the first CORESET is associated with the target cell or the target TRP includes at least one of the following a) to d).

a) Target information of the first CORESET indicates the target cell or the target TRP.

In some embodiments, the target information includes at least one of the following of the first CORESET: a TCI; QCL information in a TCI; an RS included in a TCI, which is an RS in QCL information included in a TCI, where subsequent embodiments are similar; QCL information of an RS included in a TCI; or an RS associated with QCL information of an RS included in a TCI.

In some embodiments, that the target information indicates the target cell or the target TRP includes at least one of the following 1 to 3.

1. The configuration information of the target information includes a network node identifier or network node related information of the target cell. For example, the configuration information of the target information includes PCI or PCI related information or a cell ID or cell ID related information of another cell (that is, the target cell, where the following is similar thereto).

2. The configuration information of the target information includes a network node identifier or network node related information of the target TRP. For example, the configuration information of the target information includes a TRP ID or TRP ID related information of another TRP (that is, the target TRP, where the following is similar thereto). It is mentioned in various embodiments of this specification that the TRP ID information may be CORESETPoolIndex.

3. The configuration information of the target information includes target signaling or a target information element (IE), and the target signaling or the target information element indicates the target cell or the target TRP.

In example a), the network configures or activates or updates related information through RRC signaling, or a Medium Access Control-Control Element (MAC-CE), or Downlink Control Information (DCI), so that the target information of the first CORESET indicates the target cell or the target TRP.

b) The first CORESET indicates the target cell or the target TRP.

In some embodiments, configuration information of the first CORESET indicates a target network node identifier or target network node related information; where the target network node includes the target cell or the target TRP.

For example, PCI or PCI related information or a cell ID or cell ID related information of another cell; and a TRP ID or TRP ID related information of another TRP are configured/activated/updated in the configuration information of the first CORESET.

In example b), the network configures or activates or updates related information through RRC signaling, or a MAC-CE, or DCI, so that the first CORESET indicates the target cell or the target TRP.

c) Scrambling information (scrambling sequence) used by the first CORESET indicates the target cell or the target TRP.

In some embodiments, the scrambling information may be used to scramble a PDCCH (pdcch-DMRS-ScramblingID).

In example c), the network configures or activates or updates related information through RRC signaling, or a MAC-CE, or DCI, so that the scrambling information used by the first CORESET indicates the target cell or the target TRP.

d) related configuration information of a TRP associated with the first CORESET indicates the target cell or the target TRP.

In some embodiments, related configuration information of a TRP to which the first CORESET belongs indicates a target network node identifier or target network node related information; where the target network node includes the target cell or the target TRP.

For example, PCI or PCI related information or a cell ID or cell ID related information of another cell; and a TRP ID or TRP ID related information of another TRP are configured/activated/updated in the related configuration information of the TRP (an ID of the TRP may be CORESETPoolIndex) to which the first CORESET belongs.

In example d), the network configures or activates or updates related information through RRC signaling, or a MAC-CE, or DCI, so that the related configuration information of the TRP associated with the first CORESET indicates the target cell or the target TRP.

(2)

The related information of the first TRP points to the target cell or the target TRP mentioned in 2) of the embodiment 100.

In some embodiments, the first TRP includes at least one of the following: a TRP with an index 0; a TRP with the smallest index; a TRP with the largest index; a TRP including CORESET #0; a TRP including a CORESET with the smallest index; a TRP including a CORESET with the largest index; a TRP indicated by the network device; or a TRP reported by the terminal device.

In some embodiments, that the related information of the first TRP points to the target cell includes at least one of the following a) or b):

a) related configuration information of the first TRP includes a target network node identifier or target network node related information.

For example, a related configuration of the first TRP includes PCI or PCI related information or a cell ID or cell ID related information of the target cell.

In some embodiments, the related configuration information of the first TRP includes at least one of the following and/or configuration information associated with at least one of the following: PDCCH configuration information, namely, PDCCH-config; or a control resource set resource pool index, namely, CORESETPoolIndex.

In example a), the network configures or activates or updates the related information through RRC signaling, or a MAC-CE, or DCI, so that the related configuration information of the first TRP includes a target network node identifier or target network node related information.

b) related information of a cell to which the first TRP belongs includes a target network node identifier or target network node related information; where the target network node includes the target cell or the target TRP.

For example, related information of a cell to which the first TRP belongs includes PCI or PCI related information or a cell ID or cell ID related information (for example, ServingCellConfigCommon) of the target cell.

In some embodiments, the related information of the cell in this example includes at least one of the following and/or configuration information associated with at least one of the following: cell group configuration information (CellGroupConfig); special cell configuration information (SpCellConfig); reconfiguration with synchronization information (ReconfigurationWithSync); serving cell configuration information (ServingCellConfig); or serving cell common configuration information (ServingCellConfigCommon).

In example b), the network configures or activates or updates related information through RRC signaling, or a MAC-CE, or DCI, so that the related information of the cell to which the first TRP belongs includes a target network node identifier or target network node related information.

(3)

The first RS points to the target cell or the target TRP mentioned in 3) of the embodiment 100.

In some embodiments, the first RS satisfies at least one of the following: an index of a resource set of the first RS is 0 (for example, the ID of the resource set), where in this example, the resource set with the index 0 includes the first RS; an index of a resource set of the first RS is the smallest; an index of a resource set of the first RS is the largest; an index of the first RS is 0; an index of the first RS is the smallest; an index of the first RS is the largest; the first RS is a Path Loss RS (PL RS); the first RS is indicated by the network device; or the first RS is reported by the terminal device.

For example, the ID of the resource set of the first RS is 0 or the lowest ID or the highest ID; the resource ID of the first RS is 0 or the lowest ID or the highest ID; and the first RS is the PL RS.

In some embodiments, when the first RS is a path loss reference reference signal, the path loss reference reference signal satisfies at least one of the following: a reference signal resource index of the path loss reference reference signal is 0, where the reference signal resource index is used for power control indication, that is, an index in power control, and in this example, the reference signal resource with the index 0 includes the path loss reference reference signal; the reference signal resource index of the path loss reference reference signal is the smallest; the reference signal resource index of the path loss reference reference signal is the largest; a related index (that is, an index of the first RS, where the following is similar thereto) is 0; the related index is the smallest; or the related index is the largest.

For example, an RS resource ID of the PL RS or a related ID of the PL RS is 0 or the lowest ID or the highest ID.

In some embodiments, when the first RS is a path loss reference reference signal, the path loss reference reference signal is used for at least one of the following: a PUCCH; a Physical Uplink Shared Channel (PUSCH); a Sounding Reference Signal (SRS); or a Physical Random Access Channel (PRACH).

In some embodiments, that the first RS points to the target cell or the target TRP includes: configuration information of at least one of the following includes a target network node identifier or target network node related information: the first RS; QCL information of the first RS; or an RS associated with QCL information of the first RS; where the target network node includes the target cell or the target TRP.

For example, the configuration information of the first RS, the QCL information of the first RS, or the RS associated with the QCL information of the first RS includes PCI or PCI related information or a cell ID or cell ID related information of another cell; and a TRP ID or TRP ID related information of another TRP.

In this example, the network configures or activates or updates related information through RRC signaling, or a MAC-CE, or DCI, so that the first RS points to the target cell or the target TRP.

(4)

The first TCI points to the target cell or the target TRP mentioned in 4) of the embodiment 100.

In some embodiments, the first TCI includes at least one of the following: a TCI with the smallest index configured by RRC; a TCI with the largest index configured by RRC; a TCI configured by RRC; a TCI with the smallest index configured by RRC and activated by a MAC CE; a TCI with the largest index configured by RRC and activated by a MAC CE; a TCI configured by RRC and activated by a MAC CE; a TCI indicated by the network device; or a TCI reported by the terminal device.

In some embodiments, the first TCI is used for beam indication of at least one of the following: a PDCCH; a PDSCH; a synchronization signal/PBCH block (SS/PBCH Block, SSB); a Channel State Information-Reference Signal (CSI-RS); a PUSCH; an SRS; a PUCCH; or a PRACH.

In some embodiments, that the first TCI points to the target cell or the target TRP includes: configuration information of at least one of the following includes a target network node identifier or target network node related information: the first TCI; QCL information in the first TCI; an RS included in the first TCI; QCL information of an RS included in the first TCI; or an RS associated with QCL information of an RS included in the first TCI; where the target network node includes the target cell or the target TRP.

The RS included in the first TCI is the RS in the QCL information in the first TCI.

For example, the configuration information of the first TCI, or the QCL in the first TCI, or the RS included in the first TCI, or the QCL of the RS included in the first TCI, or the RS associated with the QCL information of the RS included in the first TCI includes PCI or PCI related information or a cell ID or cell ID related information of another cell; and a TRP ID or TRP ID related information of another TRP.

In this example, the network configures or activates or updates related information through RRC signaling, or a MAC-CE, or DCI, so that the first TCI points to the target cell or the target TRP.

(5)

The first spatial relation information points to the target cell or the target TRP mentioned in 5) of the embodiment 100.

In some embodiments, the first spatial relation information includes at least one of the following: PUCCH spatial relation information; PUCCH information used for beam indication; SRS spatial relation information; or SRS information used for beam indication.

In some embodiments, the PUCCH satisfies at least one of the following: an index of a PUCCH resource set of the PUCCH is 0; an index of a PUCCH resource set (PUCCH-ResourceSetId) of the PUCCH is the smallest; an index of a PUCCH resource set of the PUCCH is the largest; a PUCCH resource set of the PUCCH is indicated by the network device; a PUCCH resource set of the PUCCH is reported by the terminal device; a PUCCH resource (PUCCH-ResourceId) index is 0; a PUCCH resource index is the smallest; a PUCCH resource index is the largest; a PUCCH resource index is indicated by the network device; or a PUCCH resource index is reported by the terminal device.

For example, for PUCCH spatial relation info or information used for beam indication, the PUCCH is at least one of the following: 1) PUCCH-ResourceSetId is 0, or the lowest ID, or the highest ID, a PUCCH-ResourceSet indicated by the network device, or a PUCCH-ResourceSet indicated by the terminal device to the network device; 2) PUCCH-ResourceId is 0, or the lowest ID, or the highest ID, a PUCCH-Resource indicated by the network device, or a PUCCH-Resource indicated by the terminal device to the network device; or 3) a PUCCH indicated by the network device, or a PUCCH indicated by the terminal device to the network device.

In some embodiments, the SRS satisfies at least one of the following: an index of an SRS resource set of the SRS is 0; an index of an SRS resource set of the SRS is the smallest; an index of an SRS resource set of the SRS is the largest; an SRS resource set of the SRS is indicated by the network device; an SRS resource set of the SRS is reported by the terminal device; an SRS resource index is 0; an SRS resource index is the smallest; an SRS resource index is the largest; an SRS resource index is indicated by the network device; or an SRS resource index is reported by the terminal device.

For example, for SRS spatial relation info or information used for beam indication, the SRS is at least one of the following: 1) SRS-ResourceSetId is 0, or the lowest ID, or the highest ID, an SRS-ResourceSet indicated by the network device, or an SRS-ResourceSet indicated by the terminal device to the network device; 2) SRS-ResourceId is 0, or the lowest ID, or the highest ID, an SRS-Resource indicated by the network device, or an SRS-Resource indicated by the terminal device to the network device; or 3) an SRS indicated by the network device, or an SRS indicated by the terminal device to the network device.

In some embodiments, that the first spatial relation information points to the target cell or the target TRP includes: configuration information of at least one of the following includes a target network node identifier or target network node related information: the first spatial relation information; an RS in the first spatial relation information; QCL information of the RS in the first spatial relation information; or an RS associated with QCL information of the RS in the first spatial relation information; where the target network node includes the target cell or the target TRP.

For example, configuration information of the first Spatial relation info, or the RS in the first Spatial relation info, or the QCL of the RS in the first Spatial relation info, or the RS associated with the QCL information of the RS in the first Spatial relation info includes PCI or PCI related information or a cell ID or cell ID related information of another cell; and a TRP ID or TRP ID related information of another TRP.

In this example, the network configures or activates or updates related information through RRC signaling, or a MAC-CE, or DCI, so that the first spatial relation information points to the target cell or the target TRP.

(6)

The first RACH resource points to the target cell or the target TRP mentioned in 6) of the embodiment 100.

In some embodiments, at least one of the following and/or configuration information of at least one of the following includes a target network node identifier or target network node related information: the SSB associated with the first RACH resource; QCL information of the SSB associated with the first RACH resource; or an RS associated with the QCL information of the SSB associated with the first RACH resource; where the target network node includes the target cell or the target TRP.

For example, configuration information of the SSB associated with the first RACH resource, or the QCL of the SSB associated with the first RACH resource, or the RS associated with the QCL information of the SSB associated with the first RACH resource includes PCI or PCI related information or a cell ID or cell ID related information of another cell; and a TRP ID or TRP ID related information of another TRP.

In this example, the network configures or activates or updates related information through RRC signaling, or a MAC-CE, or DCI, so that the first RACH resource points to the target cell or the target TRP.

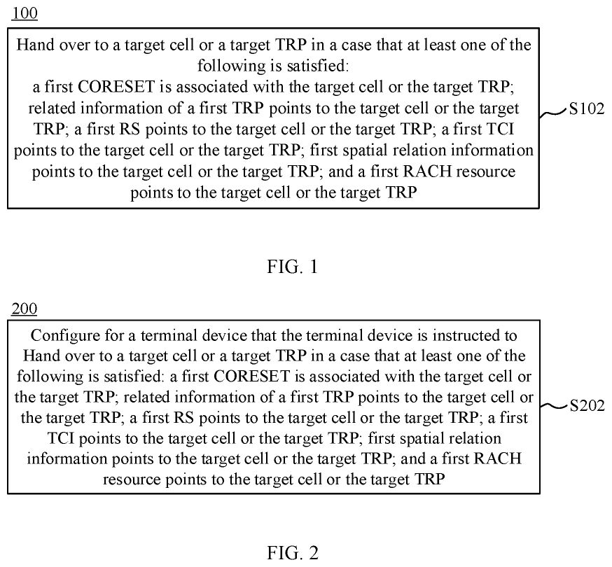

The cell handover method according to the embodiments of the present application is described in detail above with reference to FIG. 1. A cell handover method according to another embodiment of the present application is described in detail below with reference to FIG. 2. It may be understood that the interaction between the network device and the terminal device described on the network device side is the same as that described on the terminal device side in the method shown in FIG. 1. To avoid repetition, related descriptions are appropriately omitted.

FIG. 2 is a schematic flowchart of an implementation of a cell handover method according to an embodiment of the present application, where the method can be performed by the network device side. As shown in FIG. 2, the method 200 includes the following steps:

S202: Configure for a terminal device that the terminal device is instructed to hand over to a target cell or a target TRP in a case that at least one of the following is satisfied: a first CORESET is associated with the target cell or the target TRP; related information of a first TRP points to the target cell or the target TRP; a first RS points to the target cell or the target TRP; a first TCI points to the target cell or the target TRP; first spatial relation information points to the target cell or the target TRP; or a first RACH resource points to the target cell or the target TRP.

The embodiments of the present application provide various manners to implicitly instruct the terminal device to perform cell handover, and the network device does not need to explicitly send RRC reconfiguration signaling, which improves the flexibility of the system and reduces the cell handover delay.

As an embodiment, the first CORESET includes at least one of the following: a CORESET #0; a CORESET with the smallest index; a CORESET with the largest index; a CORESET configured by the network device; or a CORESET reported by the terminal device.

As an embodiment, that the first CORESET is associated with the target cell or the target TRP includes at least one of the following: target information of the first CORESET indicates the target cell or the target TRP; the first CORESET indicates the target cell or the target TRP; scrambling information used by the first CORESET indicates the target cell or the target TRP; or related configuration information of a TRP associated with the first CORESET indicates the target cell or the target TRP.

As an embodiment, the target information includes at least one of the following of the first CORESET: a TCI; quasi co-location QCL information in a TCI; an RS included in a TCI; QCL information of an RS included in a TCI; or an RS associated with QCL information of an RS included in a TCI.

As an embodiment, that the target information indicates the target cell or the target TRP includes at least one of the following: configuration information of the target information includes a network node identifier or network node related information of the target cell; configuration information of the target information includes a network node identifier or network node related information of the target TRP; or configuration information of the target information includes target signaling or a target information element, and the target signaling or the target information element indicates the target cell or the target TRP.

As an embodiment, that the first CORESET indicates the target cell or the target TRP includes: configuration information of the first CORESET indicates a target network node identifier or target network node related information; where the target network node includes the target cell or the target TRP.

As an embodiment, the scrambling information is used to scramble a physical downlink control channel PDCCH.

As an embodiment, that the related configuration information of the TRP associated with the first CORESET points to the target cell or the target TRP includes: related configuration information of a TRP to which the first CORESET belongs indicates a target network node identifier or target network node related information; where the target network node includes the target cell or the target TRP.

As an embodiment, the first TRP includes at least one of the following: a TRP with an index 0; a TRP with the smallest index; a TRP with the largest index; a TRP including CORESET #0; a TRP including a CORESET with the smallest index; a TRP including a CORESET with the largest index; a TRP indicated by the network device; or a TRP reported by the terminal device.

As an embodiment, that the related information of the first TRP points to the target cell includes at least one of the following: the related configuration information of the first TRP includes a target network node identifier or target network node related information; or related information of a cell to which the first TRP belongs includes a target network node identifier or target network node related information; where the target network node includes the target cell or the target TRP.

As an embodiment, the related configuration information of the first TRP includes at least one of the following and/or configuration information associated with at least one of the following: PDCCH configuration information; or a control resource set resource pool index.

As an embodiment, the related information of the cell in this example includes at least one of the following and/or configuration information associated with at least one of the following: cell group configuration information; special cell configuration information; reconfiguration with synchronization information; serving cell configuration information; or serving cell common configuration information.

As an embodiment, the first RS satisfies at least one of the following: an index of a resource set of the first RS is 0; an index of a resource set of the first RS is the smallest; an index of a resource set of the first RS is the largest; an index of the first RS is 0; an index of the first RS is the smallest; an index of the first RS is the largest; the first RS is a path loss reference reference signal; the first RS is indicated by the network device; or the first RS is reported by the terminal device.

As an embodiment, the path loss reference reference signal satisfies at least one of the following: a reference signal resource index of the path loss reference reference signal is 0; the reference signal resource index of the path loss reference reference signal is the smallest; the reference signal resource index of the path loss reference reference signal is the largest; a related index is 0; the related index is the smallest; or the related index is the largest.

As an embodiment, the path loss reference signal is used for at least one of the following: a PUCCH; a PUSCH; an SRS; or a PRACH.

As an embodiment, that the first RS points to the target cell or the target TRP includes: configuration information of at least one of the following includes a target network node identifier or target network node related information: the first RS; QCL information of the first RS; or an RS associated with QCL information of the first RS; where the target network node includes the target cell or the target TRP.

As an embodiment, the first TCI includes at least one of the following: a TCI with the smallest index configured by radio resource control RRC; a TCI with the largest index configured by RRC; a TCI configured by RRC; a TCI with the smallest index configured by RRC and activated by a medium access control MAC control element CE; a TCI with the largest index configured by RRC and activated by a MAC CE; a TCI configured by RRC and activated by a MAC CE; a TCI indicated by the network device; or a TCI reported by the terminal device.

As an embodiment, the first TCI is used for beam indication of at least one of the following: a PDCCH; a PDSCH; an SSB; a CSI-RS; a PUSCH; an SRS; a PUCCH; or a PRACH.

As an embodiment, that the first TCI points to the target cell or the target TRP includes: configuration information of at least one of the following includes a target network node identifier or target network node related information: the first TCI; QCL information in the first TCI; an RS included in the first TCI; QCL information of an RS included in the first TCI; or an RS associated with QCL information of an RS included in the first TCI; where the target network node includes the target cell or the target TRP.

As an embodiment, the first spatial relation information includes at least one of the following: PUCCH spatial relation information; PUCCH information used for beam indication; SRS spatial relation information; or SRS information used for beam indication.

As an embodiment, the PUCCH satisfies at least one of the following: an index of a PUCCH resource set of the PUCCH is 0; an index of a PUCCH resource set of the PUCCH is the smallest; an index of a PUCCH resource set of the PUCCH is the largest; a PUCCH resource set of the PUCCH is indicated by the network device; a PUCCH resource set of the PUCCH is reported by the terminal device; a PUCCH resource index is 0; a PUCCH resource index is the smallest; a PUCCH resource index is the largest; a PUCCH resource index is indicated by the network device; or a PUCCH resource index is reported by the terminal device.

As an embodiment, the SRS satisfies at least one of the following: an index of an SRS resource set of the SRS is 0; an index of an SRS resource set of the SRS is the smallest; an index of an SRS resource set of the SRS is the largest; an SRS resource set of the SRS is indicated by the network device; an SRS resource set of the SRS is reported by the terminal device; an SRS resource index is 0; an SRS resource index is the smallest; an SRS resource index is the largest; an SRS resource index is indicated by the network device; or an SRS resource index is reported by the terminal device.

As an embodiment, that the first spatial relation information points to the target cell or the target TRP includes: configuration information of at least one of the following includes a target network node identifier or target network node related information: the first spatial relation information; an RS in the first spatial relation information; QCL information of the RS in the first spatial relation information; or an RS associated with QCL information of the RS in the first spatial relation information; where the target network node includes the target cell or the target TRP.

As an embodiment, that the first RACH resource points to the target cell or the target TRP includes: at least one of the following and/or configuration information of at least one of the following includes a target network node identifier or target network node related information: the SSB associated with the first RACH resource; QCL information of the SSB associated with the first RACH resource; or an RS associated with the QCL information of the SSB associated with the first RACH resource; where the target network node includes the target cell or the target TRP.

As an embodiment, the handing over to the target cell or the target TRP includes at least one of the following: an anchor node hands over to the target cell; an anchor node remains unchanged and in a case that there are multiple TRPs, a cell associated with a TRP of a non-anchor node is handed over; configuration information of the target cell is used; CORESET #0 belongs to the target cell; a PDCCH belongs to the target cell; a special cell is handed over to the target cell; or a network node identifier or network node related information associated with a resource pool index of a control resource set changes.

As an embodiment, the configuration information of the target cell includes at least one of the following: cell group configuration; special cell configuration; reconfiguration with synchronization; serving cell common configuration; serving cell configuration; a TCI; QCL information; a path loss reference reference signal; a RACH resource; or scrambling information.

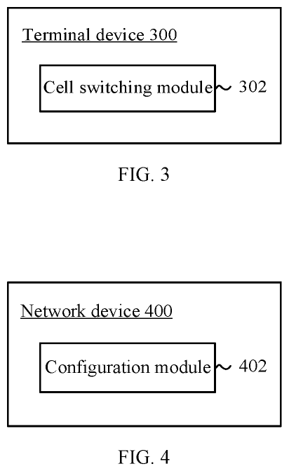

The cell handover method according to the embodiments of the present application is described in detail above with reference to FIG. 1 and FIG. 2. The terminal device according to the embodiments of the present application will be described in detail below with reference to FIG. 3.

FIG. 3 is a schematic structural diagram of a terminal device according to an embodiment of the present application. As shown in FIG. 3, a terminal device 300 includes: a cell handover module 302, configured to hand over to a target cell or a target TRP in a case that at least one of the following is satisfied: a first CORESET is associated with the target cell or the target TRP; related information of a first TRP points to the target cell or the target TRP; a first RS points to the target cell or the target TRP; a first TCI points to the target cell or the target TRP; first spatial relation information points to the target cell or the target TRP; or a first RACH resource points to the target cell or the target TRP.

The embodiments of the present application provide various manners to implicitly instruct the terminal device to perform cell handover, and the network device does not need to explicitly send RRC reconfiguration signaling, which improves the flexibility of the system and reduces the cell handover delay.

As an embodiment, the first CORESET includes at least one of the following: a CORESET #0; a CORESET with the smallest index; a CORESET with the largest index; a CORESET configured by the network device; or a CORESET reported by the terminal device.

As an embodiment, that the first CORESET is associated with the target cell or the target TRP includes at least one of the following: target information of the first CORESET indicates the target cell or the target TRP; the first CORESET indicates the target cell or the target TRP; scrambling information used by the first CORESET indicates the target cell or the target TRP; or related configuration information of a TRP associated with the first CORESET indicates the target cell or the target TRP.

As an embodiment, the target information includes at least one of the following of the first CORESET: a TCI; quasi co-location QCL information in a TCI; an RS included in a TCI; QCL information of an RS included in a TCI; or an RS associated with QCL information of an RS included in a TCI.

As an embodiment, that the target information indicates the target cell or the target TRP includes at least one of the following: configuration information of the target information includes a network node identifier or network node related information of the target cell; configuration information of the target information includes a network node identifier or network node related information of the target TRP; or configuration information of the target information includes target signaling or a target information element, and the target signaling or the target information element indicates the target cell or the target TRP.

As an embodiment, that the first CORESET indicates the target cell or the target TRP includes: configuration information of the first CORESET indicates a target network node identifier or target network node related information; where the target network node includes the target cell or the target TRP.

As an embodiment, the scrambling information is used to scramble a physical downlink control channel PDCCH.

As an embodiment, that the related configuration information of the TRP associated with the first CORESET points to the target cell or the target TRP includes: related configuration information of a TRP to which the first CORESET belongs indicates a target network node identifier or target network node related information; where the target network node includes the target cell or the target TRP.

As an embodiment, the first TRP includes at least one of the following: a TRP with an index 0; a TRP with the smallest index; a TRP with the largest index; a TRP including CORESET #0; a TRP including a CORESET with the smallest index; a TRP including a CORESET with the largest index; a TRP indicated by the network device; or a TRP reported by the terminal device.

As an embodiment, that the related information of the first TRP points to the target cell includes at least one of the following: the related configuration information of the first TRP includes a target network node identifier or target network node related information; or related information of a cell to which the first TRP belongs includes a target network node identifier or target network node related information; where the target network node includes the target cell or the target TRP.

As an embodiment, the related configuration information of the first TRP includes at least one of the following and/or configuration information associated with at least one of the following: PDCCH configuration information; or a control resource set resource pool index.

As an embodiment, the related information of the cell in this example includes at least one of the following and/or configuration information associated with at least one of the following: cell group configuration information; special cell configuration information; reconfiguration with synchronization information; serving cell configuration information; or serving cell common configuration information.

As an embodiment, the first RS satisfies at least one of the following: an index of a resource set of the first RS is 0; an index of a resource set of the first RS is the smallest; an index of a resource set of the first RS is the largest; an index of the first RS is 0; an index of the first RS is the smallest; an index of the first RS is the largest; the first RS is a path loss reference reference signal; the first RS is indicated by the network device; or the first RS is reported by the terminal device.

As an embodiment, the path loss reference reference signal satisfies at least one of the following: a reference signal resource index of the path loss reference reference signal is 0; the reference signal resource index of the path loss reference reference signal is the smallest; the reference signal resource index of the path loss reference reference signal is the largest; a related index is 0; the related index is the smallest; or the related index is the largest.

As an embodiment, the path loss reference reference signal is used for at least one of the following: a PUCCH; a PUSCH; an SRS; or a PRACH.

As an embodiment, that the first RS points to the target cell or the target TRP includes: configuration information of at least one of the following includes a target network node identifier or target network node related information: the first RS; QCL information of the first RS; or an RS associated with QCL information of the first RS; where the target network node includes the target cell or the target TRP.

As an embodiment, the first TCI includes at least one of the following: a TCI with the smallest index configured by radio resource control RRC; a TCI with the largest index configured by RRC; a TCI configured by RRC; a TCI with the smallest index configured by RRC and activated by a medium access control MAC control element CE; a TCI with the largest index configured by RRC and activated by a MAC CE; a TCI configured by RRC and activated by a MAC CE; a TCI indicated by the network device; or a TCI reported by the terminal device.

As an embodiment, the first TCI is used for beam indication of at least one of the following: a PDCCH; a PDSCH; an SSB; a CSI-RS; a PUSCH; an SRS; a PUCCH; or a PRACH.

As an embodiment, that the first TCI points to the target cell or the target TRP includes: configuration information of at least one of the following includes a target network node identifier or target network node related information: the first TCI; QCL information in the first TCI; an RS included in the first TCI; QCL information of an RS included in the first TCI; or an RS associated with QCL information of an RS included in the first TCI; where the target network node includes the target cell or the target TRP.

As an embodiment, the first spatial relation information includes at least one of the following: PUCCH spatial relation information; PUCCH information used for beam indication; SRS spatial relation information; or SRS information used for beam indication.

As an embodiment, the PUCCH satisfies at least one of the following: an index of a PUCCH resource set of the PUCCH is 0; an index of a PUCCH resource set of the PUCCH is the smallest; an index of a PUCCH resource set of the PUCCH is the largest; a PUCCH resource set of the PUCCH is indicated by the network device; a PUCCH resource set of the PUCCH is reported by the terminal device; a PUCCH resource index is 0; a PUCCH resource index is the smallest; a PUCCH resource index is the largest; a PUCCH resource index is indicated by the network device; or a PUCCH resource index is reported by the terminal device.

As an embodiment, the SRS satisfies at least one of the following: an index of an SRS resource set of the SRS is 0; an index of an SRS resource set of the SRS is the smallest; an index of an SRS resource set of the SRS is the largest; an SRS resource set of the SRS is indicated by the network device; an SRS resource set of the SRS is reported by the terminal device; an SRS resource index is 0; an SRS resource index is the smallest; an SRS resource index is the largest; an SRS resource index is indicated by the network device; or an SRS resource index is reported by the terminal device.

As an embodiment, that the first spatial relation information points to the target cell or the target TRP includes: configuration information of at least one of the following includes a target network node identifier or target network node related information: the first spatial relation information; an RS in the first spatial relation information; QCL information of the RS in the first spatial relation information; and an RS associated with QCL information of the RS in the first spatial relation information; where the target network node includes the target cell or the target TRP.

As an embodiment, that the first RACH resource points to the target cell or the target TRP includes: at least one of the following and/or configuration information of at least one of the following includes a target network node identifier or target network node related information: the SSB associated with the first RACH resource; QCL information of the SSB associated with the first RACH resource; or an RS associated with the QCL information of the SSB associated with the first RACH resource; where the target network node includes the target cell or the target TRP.

As an embodiment, the handing over to the target cell or the target TRP includes at least one of the following: an anchor node hands over to the target cell; an anchor node remains unchanged and in a case that there are multiple TRPs, a cell associated with a TRP of a non-anchor node is handed over; configuration information of the target cell is used; CORESET #0 belongs to the target cell; a PDCCH belongs to the target cell; a special cell is handed over to the target cell; or a network node identifier or network node related information associated with a resource pool index of a control resource set changes.

As an embodiment, the configuration information of the target cell includes at least one of the following: cell group configuration; special cell configuration; reconfiguration with synchronization; serving cell common configuration; serving cell configuration; a TCI; QCL information; a path loss reference reference signal; a RACH resource; or scrambling information.

For the terminal device 300 according to the embodiments of the present application, refer to the flow corresponding to the method 100 according to the embodiments of the present application. Furthermore, each unit/module of the terminal device 300 and the foregoing other operations and/or functions are used to implement the corresponding flow of the method 100, can achieve the same or equivalent technical effect, and will no longer be described here for the purpose of brevity.

FIG. 4 is a schematic structural diagram of a network device according to an embodiment of the present application. As shown in FIG. 4, a network device 400 includes: a configuration module 402, configured to configure for a terminal device that the terminal device is instructed to hand over to a target cell or a target TRP in a case that at least one of the following is satisfied: a first CORESET is associated with the target cell or the target TRP; related information of a first TRP points to the target cell or the target TRP; a first RS points to the target cell or the target TRP; a first TCI points to the target cell or the target TRP; first spatial relation information points to the target cell or the target TRP; or a first RACH resource points to the target cell or the target TRP.

The embodiments of the present application provide various manners to implicitly instruct the terminal device to perform cell handover, and the network device does not need to explicitly send RRC reconfiguration signaling, which improves the flexibility of the system and reduces the cell handover delay.

As an embodiment, the first CORESET includes at least one of the following: a CORESET #0; a CORESET with the smallest index; a CORESET with the largest index; a CORESET configured by the network device; or a CORESET reported by the terminal device.

As an embodiment, that the first CORESET is associated with the target cell or the target TRP includes at least one of the following: target information of the first CORESET indicates the target cell or the target TRP; the first CORESET indicates the target cell or the target TRP; scrambling information used by the first CORESET indicates the target cell or the target TRP; or related configuration information of a TRP associated with the first CORESET indicates the target cell or the target TRP.

As an embodiment, the target information includes at least one of the following of the first CORESET: a TCI; QCL information in a TCI; an RS included in a TCI; QCL information of an RS included in a TCI; or an RS associated with QCL information of an RS included in a TCI.

As an embodiment, that the target information indicates the target cell or the target TRP includes at least one of the following: configuration information of the target information includes a network node identifier or network node related information of the target cell; configuration information of the target information includes a network node identifier or network node related information of the target TRP; and configuration information of the target information includes target signaling or a target information element, or the target signaling or the target information element indicates the target cell or the target TRP.

As an embodiment, that the first CORESET indicates the target cell or the target TRP includes: configuration information of the first CORESET indicates a target network node identifier or target network node related information; where the target network node includes the target cell or the target TRP.

As an embodiment, the scrambling information is used to scramble a physical downlink control channel PDCCH.

As an embodiment, that the related configuration information of the TRP associated with the first CORESET points to the target cell or the target TRP includes: related configuration information of a TRP to which the first CORESET belongs indicates a target network node identifier or target network node related information; where the target network node includes the target cell or the target TRP.

As an embodiment, the first TRP includes at least one of the following: a TRP with an index 0; a TRP with the smallest index; a TRP with the largest index; a TRP including CORESET #0; a TRP including a CORESET with the smallest index; a TRP including a CORESET with the largest index; a TRP indicated by the network device; or a TRP reported by the terminal device.

As an embodiment, that the related information of the first TRP points to the target cell includes at least one of the following: the related configuration information of the first TRP includes a target network node identifier or target network node related information; or related information of a cell to which the first TRP belongs includes a target network node identifier or target network node related information; where the target network node includes the target cell or the target TRP.

As an embodiment, the related configuration information of the first TRP includes at least one of the following and/or configuration information associated with at least one of the following: PDCCH configuration information; or a control resource set resource pool index.

As an embodiment, the related information of the cell in this example includes at least one of the following and/or configuration information associated with at least one of the following: cell group configuration information; special cell configuration information; reconfiguration with synchronization information; serving cell configuration information; or serving cell common configuration information.

As an embodiment, the first RS satisfies at least one of the following: an index of a resource set of the first RS is 0; an index of a resource set of the first RS is the smallest; an index of a resource set of the first RS is the largest; an index of the first RS is 0; an index of the first RS is the smallest; an index of the first RS is the largest; the first RS is a path loss reference reference signal; the first RS is indicated by the network device; or the first RS is reported by the terminal device.

As an embodiment, the path loss reference reference signal satisfies at least one of the following: a reference signal resource index of the path loss reference reference signal is 0; the reference signal resource index of the path loss reference reference signal is the smallest; the reference signal resource index of the path loss reference reference signal is the largest; a related index is 0; the related index is the smallest; or the related index is the largest.

As an embodiment, the path loss reference reference signal is used for at least one of the following: a PUCCH; a PUSCH; an SRS; or a PRACH.

As an embodiment, that the first RS points to the target cell or the target TRP includes: configuration information of at least one of the following includes a target network node identifier or target network node related information: the first RS; QCL information of the first RS; or an RS associated with QCL information of the first RS; where the target network node includes the target cell or the target TRP.

As an embodiment, the first TCI includes at least one of the following: a TCI with the smallest index configured by RRC; a TCI with the largest index configured by RRC; a TCI configured by RRC; a TCI with the smallest index configured by RRC and activated by a MAC CE; a TCI with the largest index configured by RRC and activated by a MAC CE; a TCI configured by RRC and activated by a MAC CE; a TCI indicated by the network device; or a TCI reported by the terminal device.

As an embodiment, the first TCI is used for beam indication of at least one of the following: a PDCCH; a PDSCH; an SSB; a CSI-RS; a PUSCH; an SRS; a PUCCH; or a PRACH.

As an embodiment, that the first TCI points to the target cell or the target TRP includes: configuration information of at least one of the following includes a target network node identifier or target network node related information: the first TCI; QCL information in the first TCI; an RS included in the first TCI; QCL information of an RS included in the first TCI; or an RS associated with QCL information of an RS included in the first TCI; where the target network node includes the target cell or the target TRP.

As an embodiment, the first spatial relation information includes at least one of the following: PUCCH spatial relation information; PUCCH information used for beam indication; SRS spatial relation information; or SRS information used for beam indication.

As an embodiment, the PUCCH satisfies at least one of the following: an index of a PUCCH resource set of the PUCCH is 0; an index of a PUCCH resource set of the PUCCH is the smallest; an index of a PUCCH resource set of the PUCCH is the largest; a PUCCH resource set of the PUCCH is indicated by the network device; a PUCCH resource set of the PUCCH is reported by the terminal device; a PUCCH resource index is 0; a PUCCH resource index is the smallest; a PUCCH resource index is the largest; a PUCCH resource index is indicated by the network device; or a PUCCH resource index is reported by the terminal device.

As an embodiment, the SRS satisfies at least one of the following: an index of an SRS resource set of the SRS is 0; an index of an SRS resource set of the SRS is the smallest; an index of an SRS resource set of the SRS is the largest; an SRS resource set of the SRS is indicated by the network device; an SRS resource set of the SRS is reported by the terminal device; an SRS resource index is 0; an SRS resource index is the smallest; an SRS resource index is the largest; an SRS resource index is indicated by the network device; or an SRS resource index is reported by the terminal device.

As an embodiment, that the first spatial relation information points to the target cell or the target TRP includes: configuration information of at least one of the following includes a target network node identifier or target network node related information: the first spatial relation information; an RS in the first spatial relation information; QCL information of the RS in the first spatial relation information; or an RS associated with QCL information of the RS in the first spatial relation information; where the target network node includes the target cell or the target TRP.

As an embodiment, that the first RACH resource points to the target cell or the target TRP includes: at least one of the following and/or configuration information of at least one of the following includes a target network node identifier or target network node related information: the SSB associated with the first RACH resource; QCL information of the SSB associated with the first RACH resource; or an RS associated with the QCL information of the SSB associated with the first RACH resource; where the target network node includes the target cell or the target TRP.

As an embodiment, the handing over to the target cell or the target TRP includes at least one of the following: an anchor node hands over to the target cell; an anchor node remains unchanged and in a case that there are multiple TRPs, a cell associated with a TRP of a non-anchor node is handed over; configuration information of the target cell is used; CORESET #0 belongs to the target cell; a PDCCH belongs to the target cell; a special cell is handed over to the target cell; or a network node identifier or network node related information associated with a resource pool index of a control resource set changes.

As an embodiment, the configuration information of the target cell includes at least one of the following: cell group configuration; special cell configuration; reconfiguration with synchronization; serving cell common configuration; serving cell configuration; a TCI; QCL information; a path loss reference reference signal; a RACH resource; or scrambling information.

For the terminal device 400 according to the embodiments of the present application, refer to the procedure corresponding to the method 200 according to the embodiments of the present application. Furthermore, each unit/module of the network device 400 and the foregoing other operations and/or functions are used to implement the corresponding procedure of the method 200, can achieve the same or equivalent technical effect, and will no longer be described here for the purpose of brevity.

The embodiments in this specification are described in a progressive manner. Each embodiment usually focuses on a difference from another embodiment. For a same or similar part of the embodiments, refer to each other. The device embodiment is described simply because the device embodiment is basically similar to the method embodiment. For related details, refer to partial description of the method embodiment.

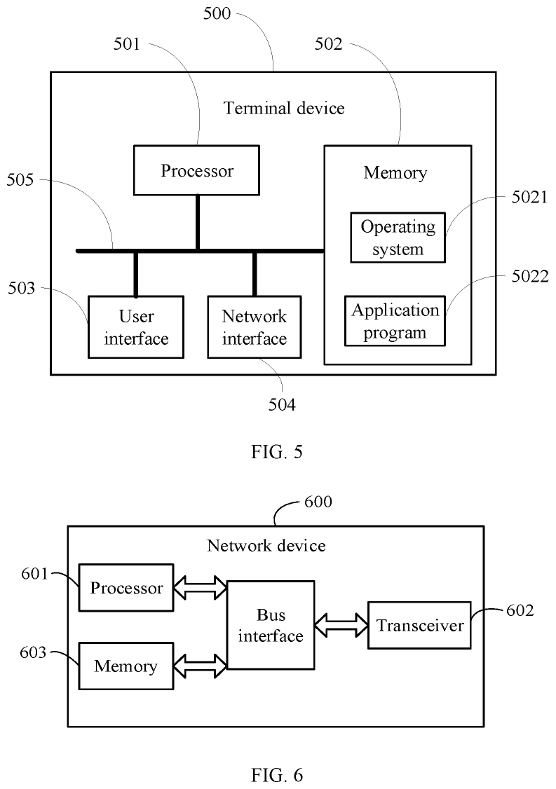

FIG. 5 is a block diagram of a terminal device according to another embodiment of the present application. As shown in FIG. 5, the terminal device 500 includes: at least one processor 501, a memory 502, at least one network interface 504, and a user interface 503. The components in the terminal device 500 are coupled together through a bus system 505. It may be understood that the bus system 505 is configured to implement connection and communication between these components. In addition to a data bus, the bus system 505 further includes a power bus, a control bus, and a status signal bus. However, for clear description, various buses are marked as the bus system 505 in FIG. 5.

The user interface 503 may include a display, a keyboard, a clicking device (for example: a mouse and a trackball), a touch panel or a touchscreen.

It can be understood that the memory 502 in this embodiment of the present application may be a volatile memory or a nonvolatile memory, or may include both a volatile memory and a nonvolatile memory. The nonvolatile memory may be a Read-only Memory (ROM), a Programmable ROM (PROM), an Erasable PROM (EPROM), an Electrically EPROM (EEPROM), or a flash memory. The volatile memory may be a Random Access Memory (RAM), which is used as an external cache. Through example but not limitative description, many forms of RAMs may be used, for example, a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The memory 502 in the system and the method that are described in the embodiments of the present application is to include but is not limited to these memories and a memory of any other proper type.

In some implementation manners, the memory 502 stores the following element, an executable module or a data structure, or a subset thereof, or an extension set thereof: an operating system 5021 and an application program 5022.

The operating system 5021 includes various system programs, such as a framework layer, a kernel layer, and a drive layer, and is configured to implement various basic services and process hardware-based tasks. The application program 5022 includes various application programs, such as a media player and a browser, and is configured to implement various application services. A program for implementing the method according to this embodiment of the present application may be included in the application program 5022.

In this embodiment of the present application, the terminal device 500 further includes a computer program that is stored in the memory 502 and that can run on the processor 501, and when the computer program is executed by the processor 501, the steps of the method 100 are implemented.

The method according to the foregoing embodiments of the present application may be performed by the processor 501, or may be implemented by the processor 501. The processor 501 may be an integrated circuit chip, and has a signal processing capability. In an implementation process, the steps in the foregoing methods may be completed by using an integrated logic circuit of hardware in the processor 501 or an instruction in a form of software. The processor 501 may be a general purpose processor, a Digital Signal Processor (DSP), an Application Specific Integrated Circuit (ASIC), a Field Programmable Gate Array (FPGA), another programmable logic device, a discrete gate, a transistor logic device, or a discrete hardware component. The processor may implement or perform the methods, the steps, and logical block diagrams that are disclosed in the embodiments of the present application. The general purpose processor may be a microprocessor, or the processor may be any conventional processor or the like. Steps of the methods disclosed with reference to the embodiments of the present application may be directly executed and accomplished through a hardware decoding processor, or may be executed and accomplished by using a combination of hardware and software modules in the decoding processor. The software module may be located in a computer-readable storage medium that is mature in the art, such as a random access memory, a flash memory, a read-only memory, a programmable read-only memory, an electrically erasable programmable memory, or a register. The computer-readable storage medium is located in the memory 502. The processor 501 reads information in the memory 502 and completes the steps of the foregoing methods in combination with the hardware of the processor 501. In some embodiments, the computer-readable storage medium stores a computer program, and when the computer program is executed by the processor 501, the steps of the foregoing method embodiment 100 are performed.

It can be understood that the embodiments described in the embodiments of the present application may be implemented by hardware, software, firmware, middleware, microcode, or a combination thereof. For implementation with hardware, the processing unit can be implemented in one or more Application Specific Integrated Circuits (ASIC), a Digital Signal Processing (DSP), a DSP Device (DSPD), a Programmable Logic Device (PLD), a Field-Programmable Gate Arrays (PFGA), general processors, controllers, micro-controllers, microprocessors, and another electronic unit for implementing the functions of the present application, or their combinations.

For implementation with software, the technologies in the embodiments of the present application may be implemented through modules (for example, procedures or functions) that perform the functions in the embodiments of the present application. The software code may be stored in a memory and executed by a processor. The memory may be implemented in or outside the processor.

The terminal device 500 can implement each process implemented by the terminal device in the foregoing embodiments, and the same or equivalent technical effect can be achieved. To avoid repetition, details are not described herein again.

Referring to FIG. 6, FIG. 6 is a structural diagram of a network device to which an embodiment of the present application is applied. The network device can implement details of the embodiment of the method 200, and achieve a same effect. As shown in FIG. 6, a network device 600 includes a processor 601, a transceiver 602, a memory 603, and a bus interface.

In this embodiment of the present application, the network device 600 further includes: a computer program stored in the memory 603 and executable on the processor 601. When the computer program is executed by the processor 601, the steps of the method 200 are implemented.

In FIG. 6, a bus architecture may include any quantity of interconnected buses and bridges, and is linked by various circuits of one or more processors represented by the processor 601 and a memory represented by the memory 603. The bus architecture may further link various other circuits such as a peripheral device, a voltage regulator, and a power management circuit together. These are all well-known in the art, and therefore are not further described in this specification. The bus interface provides interfaces. The transceiver 602 may be a plurality of elements, in other words, includes a transmitter and a receiver, and provides a unit configured to communicate with various other apparatuses on a transmission medium.

The processor 601 is responsible for managing the bus architecture and common processing, and the memory 603 may store data used when the processor 601 performs an operation.

The embodiments of the present application further provide a computer-readable storage medium. The computer-readable storage medium stores a computer program, and when a processor executes the computer program, the processes of the embodiments of the foregoing methods 100 and 200 are implemented and the same technical effect can be achieved. To avoid repetition, details are not described herein again. The computer readable storage medium is, for example, a read-only memory (ROM), a random access memory (RAM), a magnetic disk, or an optical disc.

It should be noted that, in this specification, the terms “include”, “comprise”, or any of their variants are intended to cover a non-exclusive inclusion, such that a process, a method, an article, or an apparatus that includes a list of elements not only includes those elements but also includes other elements that are not expressly listed, or further includes elements inherent to such process, method, article, or apparatus. Without more restrictions, an element defined by the statement “including a . . . ” does not exclude another same element in this process, method, article, or apparatus that includes the element.

By means of the foregoing description of the embodiments, a person skilled in the art may clearly understand that the method in the foregoing embodiments may be implemented by software in addition to a necessary universal hardware platform. Certainly, the method in the foregoing embodiments may also be implemented by hardware. However, in many cases, the former is a preferred embodiment. Based on such an understanding, the technical solutions of the present application essentially, or the part contributing to the prior art may be implemented in a form of a software product. The computer software product is stored in a storage medium (for example, a ROM/RAM, a magnetic disk, or a compact disc), and includes a plurality of instructions for instructing a terminal (which may be a mobile phone, a computer, a server, an air conditioner, a network device, or the like) to perform the method described in the embodiments of the present application.

The embodiments of the present application are described above with reference to the accompanying drawings, but the present application is not limited to the foregoing specific implementations. The foregoing specific implementations are merely schematic instead of restrictive. Under enlightenment of the present application, a person of ordinary skills in the art may make many forms without departing from aims and the protection scope of claims of the present application, all of which fall within the protection scope of the present application.

What is claimed is:

1. A cell handover method, executed by a terminal device, comprising:
handing over to a target cell or a target transmission and reception point (TRP) in a case that at least one of the following is satisfied:
a first control resource set (CORESET) is associated with the target cell or the target TRP;
related information of a first TRP points to the target cell or the target TRP;
a first reference signal (RS) points to the target cell or the target TRP;
a first transmission configuration indication (TCI) points to the target cell or the target TRP;
first spatial relation information points to the target cell or the target TRP; or
a first random access channel (RACH) resource points to the target cell or the target TRP.

2. The cell handover method according to claim 1, wherein the first CORESET comprises at least one of the following:
a CORESET #0; a CORESET with the smallest index; a CORESET with the largest index; a CORESET configured by the network device; or a CORESET reported by the terminal device.

3. The cell handover method according to claim 1, wherein that the first CORESET is associated with the target cell or the target TRP comprises at least one of the following:
target information of the first CORESET indicates the target cell or the target TRP;
the first CORESET indicates the target cell or the target TRP;
scrambling information used by the first CORESET indicates the target cell or the target TRP; or
related configuration information of a TRP associated with the first CORESET indicates the target cell or the target TRP.

4. The cell handover method according to claim 3, wherein the target information comprises at least one of the following of the first CORESET:
a TCI;
quasi co-location (QCL) information in a TCI;
an RS comprised in a TCI;
QCL information of an RS comprised in a TCI; and
an RS associated with QCL information of an RS comprised in a TCI.

5. The cell handover method according to claim 4, wherein that the target information indicates the target cell or the target TRP comprises at least one of the following:
configuration information of the target information comprises a network node identifier or network node related information of the target cell;
configuration information of the target information comprises a network node identifier or network node related information of the target TRP; or
configuration information of the target information comprises target signaling or a target information element, and the target signaling or the target information element indicates the target cell or the target TRP.

6. The cell handover method according to claim 3, wherein that the first CORESET indicates the target cell or the target TRP comprises:
configuration information of the first CORESET indicates a target network node identifier or target network node related information,
wherein the target network node comprises the target cell or the target TRP.

7. The cell handover method according to claim 3, wherein the scrambling information is used to scramble a physical downlink control channel (PDCCH).

8. The cell handover method according to claim 3, wherein that the related configuration information of the TRP associated with the first CORESET points to the target cell or the target TRP comprises:
related configuration information of a TRP to which the first CORESET belongs indicates a target network node identifier or target network node related information,
wherein the target network node comprises the target cell or the target TRP.

9. The cell handover method according to claim 1, wherein the first TRP comprises at least one of the following:
a TRP with an index 0; a TRP with the smallest index; a TRP with the largest index; a TRP comprising CORESET #0; a TRP comprising a CORESET with the smallest index; a TRP comprising a CORESET with the largest index; a TRP indicated by the network device; or a TRP reported by the terminal device.

10. The cell handover method according to claim 1, wherein that the related information of the first TRP points to the target cell comprises at least one of the following:
related configuration information of the first TRP comprises a target network node identifier or target network node related information; or
related information of a cell to which the first TRP belongs comprises a target network node identifier or target network node related information,
wherein the target network node comprises the target cell or the target TRP.

11. The cell handover method according to claim 10, wherein the related configuration information of the first TRP comprises at least one of the following or configuration information associated with at least one of the following:
PDCCH configuration information; or
a resource pool index of a control resource set.

12. The cell handover method according to claim 10, wherein the related information of a cell comprises at least one of the following or configuration information associated with at least one of the following:
cell group configuration information;
special cell configuration information;
synchronous reconfiguration information;
serving cell configuration information; or
serving cell common configuration information.

13. The cell handover method according to claim 1, wherein the first RS satisfies at least one of the following.
an index of a resource set of the first RS is 0;
an index of a resource set of the first RS is the smallest;
an index of a resource set of the first RS is the largest;
an index is 0;
an index is the smallest;
an index is the largest;
the first RS is a path loss reference reference signal;
the first RS is indicated by the network device; or
the first RS is reported by the terminal device.

14. The cell handover method according to claim 13, wherein the path loss reference reference signal satisfies at least one of the following:
a reference signal resource index of the path loss reference reference signal is 0;
a reference signal resource index of the path loss reference reference signal is the smallest;
a reference signal resource index of the path loss reference reference signal is the largest;
a related index is 0;
a related index is the smallest; or
a related index is the largest.

15. The cell handover method according to claim 13, wherein the path loss reference reference signal is used for at least one of the following:
a physical uplink control channel (PUCCH); a physical uplink shared channel (PUSCH); a sounding reference signal (SRS); or a physical random access channel (PRACH).

16. A network device, comprising:
a memory storing a computer program; and
a processor coupled to the memory and configured to execute the computer program to perform operations comprising:
configuring for a terminal device that the terminal device is instructed to hand over to a target cell or a target transmission and reception point (TRP) in a case that at least one of the following is satisfied:
a first control resource set (CORESET) is associated with the target cell or the target TRP;
related information of a first TRP points to the target cell or the target TRP;
a first reference signal (RS) points to the target cell or the target TRP;
a first transmission configuration indication (TCI) points to the target cell or the target TRP;
first spatial relation information points to the target cell or the target TRP; or
a first random access channel (RACH) resource points to the target cell or the target TRP.

17. The method according to claim 16, wherein that the first CORESET is associated with the target cell or the target TRP comprises at least one of the following:
target information of the first CORESET indicates the target cell or the target TRP;
the first CORESET indicates the target cell or the target TRP;
scrambling information used by the first CORESET indicates the target cell or the target TRP; or
related configuration information of a TRP associated with the first CORESET indicates the target cell or the target TRP.

18. The method according to claim 17, wherein that the target information indicates the target cell or the target TRP comprises at least one of the following:
configuration information of the target information comprises a network node identifier or network node related information of the target cell;
configuration information of the target information comprises a network node identifier or network node related information of the target TRP; or
configuration information of the target information comprises target signaling or a target information element, and the target signaling or the target information element indicates the target cell or the target TRP.

19. The method according to claim 17, wherein that the related configuration information of the TRP associated with the first CORESET points to the target cell or the target TRP comprises:
related configuration information of a TRP to which the first CORESET belongs indicates a target network node identifier or target network node related information,
wherein the target network node comprises the target cell or the target TRP.

20. A terminal device, comprising:
a memory storing a computer program; and
a processor coupled to the memory and configured to execute the computer program to perform operations comprising:
handing over to a target cell or a target transmission and reception point (TRP) in a case that at least one of the following is satisfied:
a first control resource set (CORESET) is associated with the target cell or the target TRP;
related information of a first TRP points to the target cell or the target TRP;
a first reference signal (RS) points to the target cell or the target TRP;
a first transmission configuration indication (TCI) points to the target cell or the target TRP;
first spatial relation information points to the target cell or the target TRP; or
a first random access channel (RACH) resource points to the target cell or the target TRP.
